(19) United States
(12) Patent Application Publication
(10) Pub. No.: US 2026/0041064 A1
(43) Pub. Date: Feb. 12, 2026

(54) QUICK RELEASE EXTENDABLE ANIMAL LEASH

(71) Applicant: Danielle Solick, Santa Cruz, CA (US)

(72) Inventor: Danielle Solick, Santa Cruz, CA (US)

(21) Appl. No.: 18/798,074

(22) Filed: Aug. 8, 2024

(51) Int. Cl. A01K 27/00

(52) U.S. Cl. CPC A01K 27/005; A01K 27/004

(57) ABSTRACT

An extendable animal leash incorporates an advanced quick release functionality within its design. Housed in an ergonomic casing for comfortable handling, the leash can be swiftly disconnected using a quick leash release button. This button triggers a mechanism involving either a pull-pin connected to a cord, string, or cable, or a magnetic pull-pin activated by a magnetic force. Upon engagement, the quick release mechanism allows the leash to detach from the housing, providing immediate separation. The leash itself, made from durable materials like nylon, polyester, or leather, is retracted by a spring recoil mechanism. Additionally, the housing features a spool locking button for setting the leash length and ensuring controlled retraction. Constructed from lightweight and durable materials such as plastic or aluminum, the housing is designed for easy opening, facilitating maintenance and reassembly of the quick release components.

### TECHNICAL FIELD

The present invention generally relates to systems and methods for providing a quick release extendable animal leash. More specifically, the present invention relates new systems and methods for providing a quick release extendable animal leash that is configured to release a leash from a housing with a single button push.

### BACKGROUND INFORMATION

The history of animal leashes dates back thousands of years, evolving significantly over time alongside human-animal relationships. Evidence of leashes can be found in ancient Egyptian art, where dogs, often depicted as companions or hunting partners, were shown on leashes made of leather or cord. The use of leashes was not limited to dogs; other animals, such as cats and even monkeys, were occasionally restrained in a similar manner. In ancient Greece and Rome, leashes were common for dogs, particularly those used for hunting or guarding. These early leashes were typically rudimentary, crafted from available materials like leather, rope, or woven fibers.

During the Middle Ages, the use of leashes continued, especially for hunting dogs. Leashes made from leather or chain were used to control and manage animals more effectively during hunts. As the domestication of dogs progressed, leashes became a more common tool for everyday use, particularly in urban settings. In the 19th century, with the rise of pet keeping as a hobby among the middle and upper classes, leashes began to be designed with more comfort and style in mind, reflecting their owners'status and the growing bond between humans and their pets.

The 20th century saw significant advancements in leash technology and design, with the introduction of various materials such as nylon. These innovations aimed to enhance durability, ease of use, and the safety of both the animal and the handler. Today, leashes come in a wide range of styles, materials, and functionalities, catering to the diverse needs of pets and their owners. The leash has thus transformed from a simple tool of restraint to a symbol of the human-animal bond, reflecting changes in societal attitudes towards pets and their roles in our lives.

While the above mentioned evolution of animal leashes has greatly improved, a need for improved animal leash technology remains.

### SUMMARY

In a first novel aspect, an extendable animal leash comprises a housing; a leash that extends out from the housing; a spring recoil mechanism configured to retract the leash into the housing; and a quick leash release button mounted on the housing.

The quick leash release button is configured to cause the leash to disconnect from the housing when engaged.

In a second novel aspect, the quick leash release button triggers a mechanism that releases the leash from a leash spool within the housing.

In a third novel aspect, the mechanism includes a pull-pin that is connected to a cord, a string, or a cable. The cord, string, or cable is also connected to the quick leash release button. Moving the quick leash release button also causes the pull-pin to move.

In a fourth novel aspect, the mechanism includes a magnetic pull-pin that is configured to move when a magnetic force is applied to the magnetic pull-pin. Pressing or engaging the quick leash release button causes a magnet to move toward the magnetic pull-in.

In a fifth novel aspect, pushing or engaging the quick leash release button causes an electrical circuit to apply a current to an electrical coil, thereby causing a magnetic field to be applied to the magnetic pull-in.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a diagram illustrating a quick release leash with a mechanical pull-pin release.

FIG. 2 is a diagram illustrating a quick release leash with a magnetic pull-pin release.

FIG. 3 is a diagram of pull-pin movement.

FIG. 4 is a diagram of leash movement after pull-pin removal.

FIG. 5 is a diagram illustrating a runaway animal with an extendable leash handle attached to the animal's leash.

FIG. 6 is a diagram illustrating a runaway animal without an extendable leash handle attached to the animal's leash.

FIG. 7 is a flowchart diagram illustrating the operational steps of the a quick release extendable leash.

### DETAILED DESCRIPTION

Reference will now be made in detail to background examples and some embodiments of the invention, examples of which are illustrated in the accompanying drawings. In the description and claims below, relational terms such as “top”, “down”, “upper”, “lower”, “top”, “bottom”, “left” and “right” may be used to describe relative orientations between different parts of a structure being described, and it is to be understood that the overall structure being described can actually be oriented in any way in three-dimensional space.

An extendable and automatically retracting animal leash is a versatile device designed to give pets more freedom while maintaining control. The leash consists of a robust plastic handle housing a retractable cord, typically made from durable nylon. Within the handle, a spring-loaded mechanism allows the cord to extend and retract smoothly. When the owner presses a button on the handle, it locks the cord at the desired length, preventing further extension. Releasing the button unlocks the cord, enabling it to retract automatically back into the handle. This feature ensures the leash remains taut, reducing the risk of tangling or tripping.

In practice, the leash is highly useful in various scenarios. For example, during a walk in a spacious park, the owner can allow their dog to explore a wider area by extending the leash fully. This provides the pet with the freedom to sniff around and play while still being under control. Conversely, in a crowded urban area, the owner can lock the leash at a shorter length, keeping the dog close to avoid potential hazards such as traffic or pedestrians. The automatic retraction feature is particularly beneficial when transitioning between these environments, as it allows the leash to be quickly and easily adjusted. Additionally, during training sessions, the leash can be used to gradually give a pet more freedom while practicing recall commands. The extendable and automatically retracting leash thus offers a balance between freedom and safety, making it an essential tool for pet owners in various settings.

The new and improved extendable animal leash introduces a groundbreaking Quick Leash Release function designed to enhance both user and animal safety in emergency situations. This advanced leash retains the core features of a robust plastic handle and a retractable nylon cord, equipped with a spring-loaded mechanism for smooth extension and retraction. However, it now includes an innovative release system integrated into the handle. In an emergency, the owner can quickly press a clearly marked button or lever, causing the leash to detach instantly from the handle. This mechanism ensures that the pet is immediately freed, preventing potential harm to both the pet and the owner.

In real-world scenarios, this Quick Leash Release function proves invaluable. For instance, if a dog suddenly becomes entangled with a cyclist or another animal, the owner can swiftly activate the release mechanism to prevent injuries. In another situation, if the leash gets tangled with the leash of another animal, the quick release ensures the dog is freed before any harm can occur. During a walk near a busy road, if the dog suddenly darts into traffic, the owner can release the leash to avoid being pulled into danger themselves. Furthermore, in case of an aggressive animal encounter, the Quick Leash Release allows the pet to escape while the owner maintains control over the handle.

The improved design also maintains convenience for everyday use. In a park, the owner can still allow their pet to explore by extending the leash fully and then quickly retracting it when needed. In urban environments, the leash can be kept short for better control. The addition of the Quick Leash Release function does not compromise these standard features but adds an extra layer of safety, making it an essential tool for pet owners who prioritize the well-being of their animals and themselves. This innovative leash is particularly beneficial for elderly or disabled pet owners who may have difficulty handling emergencies swiftly, ensuring that both pet and owner can enjoy walks with greater peace of mind.

The new Leash Quick Release functionality significantly enhances the safety of both the pet and the owner. The extendable animal leash features a housing unit containing a retractable leash made from durable materials such as nylon, polyester, or leather. This leash extends from the housing and retracts using a spring recoil mechanism within. The housing also includes an ergonomically designed handle for a comfortable grip. Central to the safety feature is a quick leash release button mounted on the housing, allowing the leash to disconnect from the housing in emergencies. When the quick leash release button is engaged, it activates an internal mechanism that causes the leash to disconnect from an internal leash spool in the housing. In one example the mechanism includes a pull-pin connected to the quick leash release button via a cord, a string, or a cable. In another example, pull-pin is magnetic and configured to move when a magnetic force is applied when the quick leash release button is engaged. The magnet may be coupled to the quick leash release button through various means such as an adhesive, a tie, a strap, a screw, a bolt, or a clip. This movement causes the pull-pin to release the leash from the spool within the housing. In yet another example, a latch mechanism may be used, which disengages the leash from the spool upon engaging the quick leash release button.

Additionally, the housing features a leash spool locking button, which in one example is positioned for easy thumb operation. This button allows the user to fix the leash at a desired length by engaging a leash spool brake mechanism within the housing, providing gradual stopping of the leash extension for smooth control. The spring recoil mechanism is tensioned to retract the leash automatically when the leash spool lock button is disengaged, keeping the leash taut and reducing the risk of tangling or tripping. In emergency scenarios, such as the leash getting caught on an object, encountering aggressive animals, or sudden traffic dangers, the quick leash release button allows for immediate disconnection of the leash, preventing injury to the pet and owner. The housing, may be made from lightweight, durable materials like plastic or aluminum, and is designed for easy handling and resilience. It can be opened and closed to re-engage the pull-pin with the leash for continued use after an emergency release. This quick release functionality provides peace of mind and enhanced safety for pet owners in various every day and emergency situations.

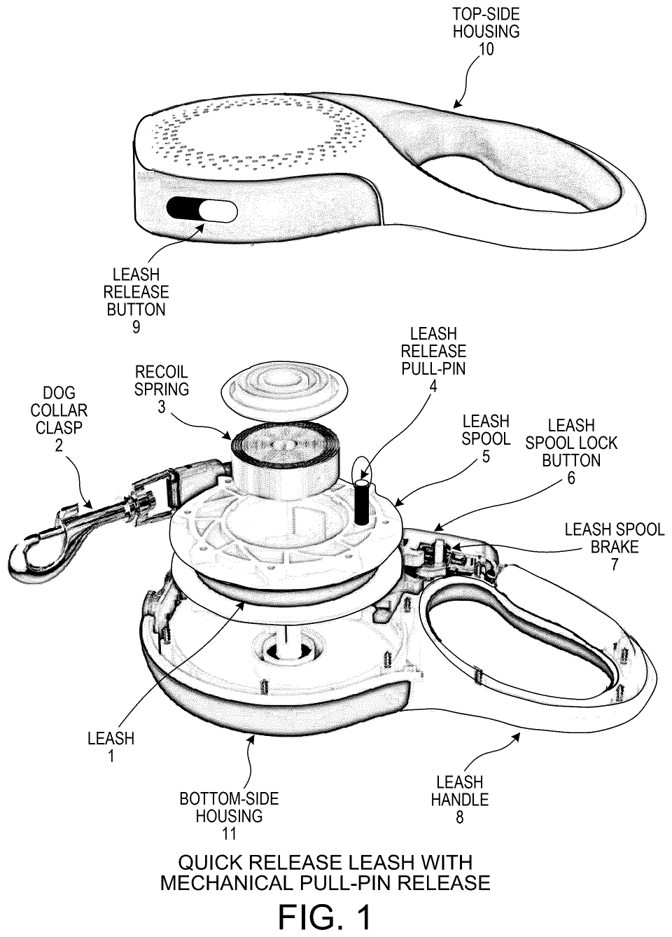

FIG. 1 is a diagram illustrating a quick release leash with a mechanical pull-pin release. The quick release leash includes a leash 1, a dog collar clasp 2, a recoil spring 3, a leash release pull-pin 4, a leash spool 5, a leash spool lock button 6, a leash spool brake 7, a leash handle 8, a leash release button 9, a top-side housing 10 and a bottom-side housing 11. In operation, the leash release pull-pin 4 connects the leash 1 to the leash spool 5. The dog collar clasp 2 is connected to one end of the leash 1 and is configured to attached to a dog collar. The recoil spring 3 is configured to cause a rotational force upon the leash spool 5. When the recoil spring 3 rotates the leash spool 5, the leash 1 is wound around the leash spool 5, thereby shortening the amount of the leash 1 that is extended outside of the housing. Rotation of the leash spool 5 is controlled by leash spool lock button 6. When the button 6 is engaged, the leash spool brake 7 is engaged thereby stopping the leash spool 5 from rotating. This stopping of the leash spool 5 causes the amount of leash extending from the housing to remain unchanged.

In one example, the quick release leash is configured so that when the quick leash release button 9 is engaged, the quick leash release pull-pin 4 is mechanically moved so that the leash 1 is no longer connected to the leash spool 5. In this scenario, the leash 1 is free to fully unspool then completely disconnect from the housing. The movement of the pull-in 4 may be achieved by attaching a wire, a cable, or a string from the leash release button to the pull-pin, so that movement of the leash release button causes movement of the pull-pin. It is noted that the quick leash release button may be located a different locations on the housing. Placing the quick leash release button along the bottom of the housing may be ideal so that the extendable leash is easily usable for both left and right handed users.

In another example, the top-side housing 10 is configured to disconnect from the bottom-side housing so to allow a user to reconnect the leash to the leash spool 5 by reinserting the leash release pull-pin 4. Once reconnected, the quick release leash is ready for continued use and the next quick release event. The top-side housing 10 and the bottom-side housing 11 may be connected via screws, a strap, a pair of mating plastic moldings, a clamp, a bolt, a pair of mating Velcro pieces, an adhesive tape, or an adhesive material.

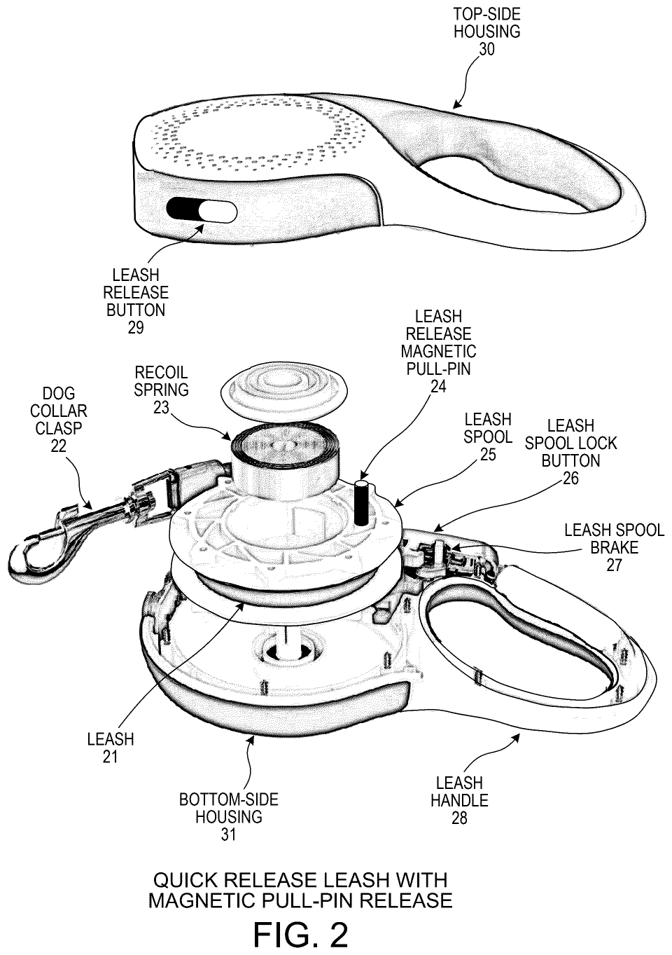

FIG. 2 is a diagram illustrating a quick release leash with a magnetic pull-pin release. The quick release leash includes a leash 21, a dog collar clasp 22, a recoil spring 23, a leash release pull-pin 24, a leash spool 25, a leash spool lock button 26, a leash spool brake 27, a leash handle 28, a leash release button 29, a top-side housing 30 and a bottom-side housing 31. In operation, the leash release pull-pin 24 connects the leash 21 to the leash spool 25. The dog collar clasp 22 is connected to one end of the leash 21 and is configured to attached to a dog collar. The recoil spring 23 is configured to cause a rotational force upon the leash spool 25. When the recoil spring 23 rotates the leash spool 25, the leash 21 is wound around the leash spool 25, thereby shortening the amount of the leash 1 that is extended outside of the housing. Rotation of the leash spool 25 is controlled by leash spool lock button 26. When the button 26 is engaged, the leash spool brake 27 is engaged thereby stopping the leash spool 25 from rotating. This stopping of the leash spool 25 causes the amount of leash extending from the housing to remain unchanged.

In one example, the quick release leash is configured so that when the quick leash release button 29 is engaged, the leash release pull-pin 24 is magnetically moved so that the leash 21 is no longer connected to the leash spool 25. In this scenario, the leash 21 is free to fully unspool then completely disconnect from the housing. The leash release button may be directly or indirectly connected to a magnet that applies a magnetic force upon the magnetic pull-pin when the leash release button is engaged.

It is noted that there is yet another embodiment where the pull-pin is moved by a magnetic force generated by an electro-magnet, which generates a magnetic field in response to electric current. One example of an electro-magnet is a coiled wire that emits a magnetic field when a current flows through the coil wire. In this fashion, the leash could use an electric button (switch) that when engaged causes an electrical circuit to close and current to flow through a coil, thereby causing an electro-magnetic field that causes the pull-pin to move and the lease to disengage from the leash spool. In this example, the electrical circuit may be powered from a battery source included in the housing. The coil would ideally be located close to the magnetic pull-pin so that the maximum amount of emitted magnetic field could be applied to the pull-pin. It is noted that the battery may be rechargeable and that power may be applied to the rechargeable battery via a power port including in the housing, such as a USB power port.

In another example, the top-side housing 10 is configured to disconnect from the bottom-side housing so to allow a user to reconnect the leash to the leash spool 5 by reinserting the leash release pull-pin 4. Once reconnected, the quick release leash is ready for continued use and the next quick release event. The top-side housing 10 and the bottom-side housing 11 may be connected via screws, a strap, a pair of mating plastic moldings, a clamp, a bolt, a pair of mating Velcro pieces, an adhesive tape, or an adhesive material.

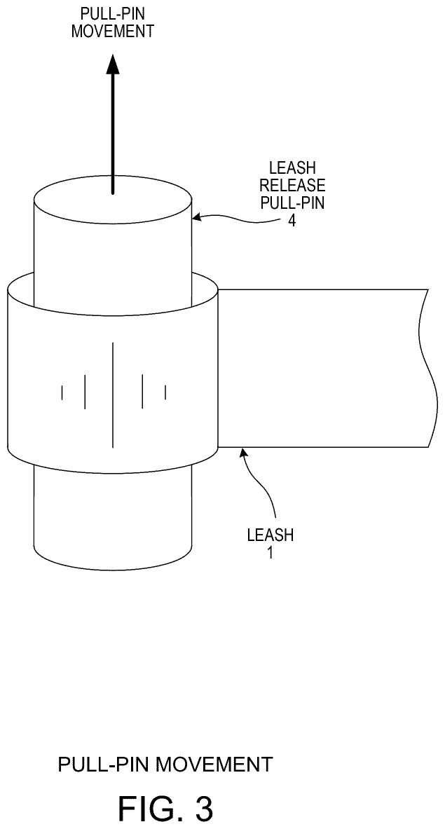

FIG. 3 is a diagram of pull-pin movement. When the pull-pin 4 is in the locked position, the leash 1 cannot pull away from the pull-pin or the leash spool 5. In order for the leash to disengage and separate from the pull-pin and the leash spool, the pull-pin must be moved out of the leash loop hole.

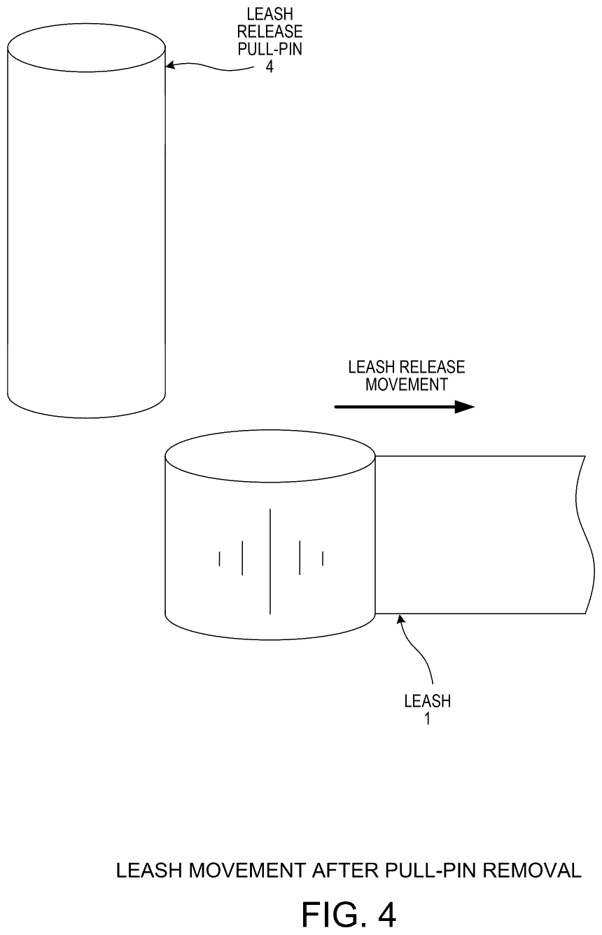

FIG. 4 is a diagram of leash movement after pull-pin removal. Once the pull-pin has been moved outside of the leash loop hole, then the leash is free to disengage from the pull-pin and the leash spool.

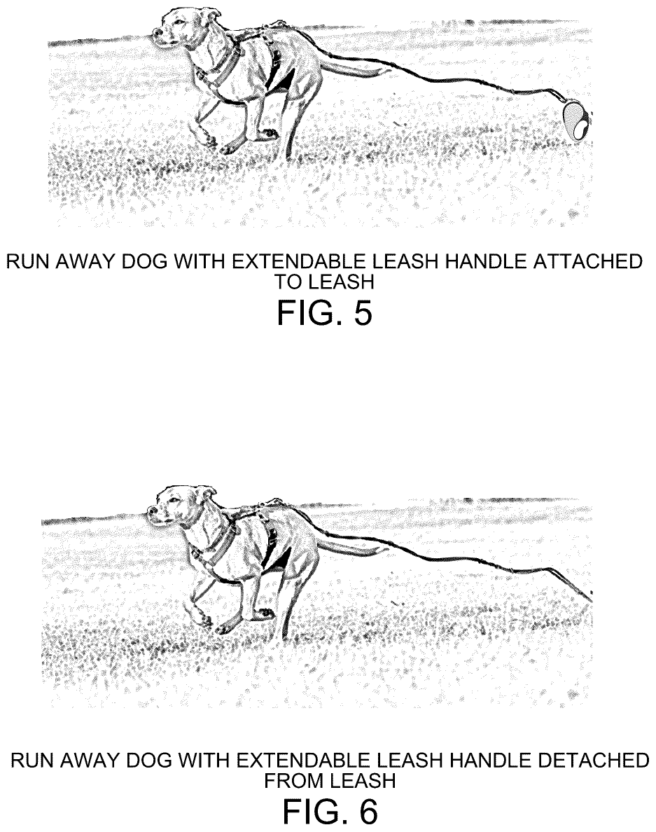

FIG. 5 is a diagram illustrating a runaway animal with an extendable leash handle attached to the animal's leash. When a dog runs away with the housing of an extendable leash still attached to the end of its leash, several problems and dangers arise, posing significant risks to the dog, the surrounding environment, and the leash housing itself. The bulky and heavy housing can cause physical harm to the dog as it dangles and bounces against the dog's body, potentially bruising or injuring the animal. The housing may also create an imbalance, causing the dog to trip, fall, or become more easily entangled in obstacles like bushes, fences, or street furniture, leading to further injuries.

Moreover, the sudden and uncontrolled movement of the housing can scare the dog, exacerbating its panic and causing it to run faster and farther away, making retrieval more difficult. In urban environments, this situation becomes even more hazardous as the dog might dart into traffic, where the housing can get caught under the wheels of vehicles, potentially causing accidents or fatal injuries to the dog. In natural settings, the housing can get snagged on tree branches or rocks, leaving the dog trapped and vulnerable to predators or harsh weather conditions.

The presence of the housing also increases the risk of the leash becoming a strangulation hazard. If the housing gets caught while the dog continues to run, the leash could tighten around the dog's neck, leading to choking or severe neck injuries. Additionally, the leash housing can damage property if it smashes into windows, cars, or other structures during the dog's flight, resulting in financial liabilities for the owner.

Furthermore, the leash housing itself is susceptible to damage. The housing, often made from plastic or lightweight materials, can crack or break upon impact with hard surfaces, rendering the retractable mechanism inoperative. If the internal spring recoil mechanism is damaged, the leash may no longer retract properly, leading to a permanently extended leash that poses additional tangling risks. The locking mechanism within the housing can also become jammed or broken, compromising the functionality of the leash.

From a psychological perspective, the experience can be highly traumatic for the dog, leading to long-term fear and anxiety about leashes or walks. For the owner, the scenario is equally distressing, filled with worry about the dog's safety and the potential harm it might cause. The panic induced by the runaway situation can delay logical thinking and immediate action, further complicating the rescue efforts. Overall, the dangers and problems associated with a dog running away with an extendable leash housing attached are multifaceted, highlighting the critical need for quick-release safety mechanisms in leash designs to prevent harm to the dog, the environment, and the leash housing itself.

FIG. 6 is a diagram illustrating a runaway animal without an extendable leash handle attached to the animal's leash. The present invention provides a solution to all the above listed problems and dangers. Once the quick release leash button is pressed, the animal can run free without the extendable leash housing attached to the end of its collar. Once the animal returns, the quick release extendable leash housing can be opened, the leash reconnected to the leash spool by inserting the pull-in into the leash loop hole and closing the housing. Thus, providing a safe and practical why to manage your pet.

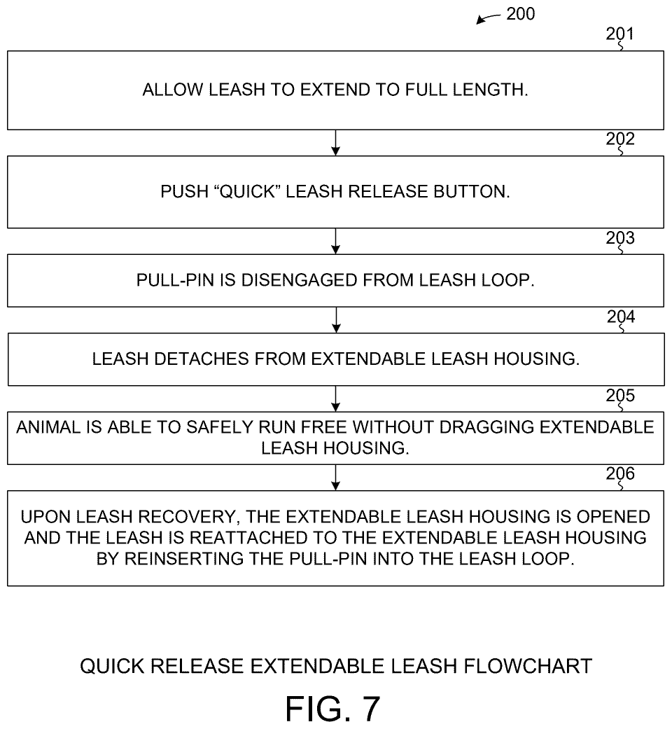

FIG. 7 is a flowchart diagram illustrating the operational steps 200 of the quick release extendable leash. In step 201, the leash is extended. In step 202, the quick leash release button is pushed, pressed or otherwise engaged. In step 203, the pull-in disengages from the leash loop, thereby disconnecting the leash from the leash spool. In step 204, the leash detaches from the extendable leash housing. In step 205, the animal is able to safely run free without dragging the extendable leash housing at the end of its leash. In step 206, upon return of the animal, the extendable leash housing is opened, and the leash is reattached to the extendable leash housing by reinserting the pull-in into the leash loop.

### Manual Hand-Powered Retractable Leash With Quick Leash Release Button

The optional manual hand-powered version of the extendable animal leash offers an innovative alternative to traditional spring recoil mechanisms, providing greater control and reliability for pet owners. This version features a robust housing that contains a durable leash, made from materials such as nylon, polyester, or leather, which extends out from the housing. Instead of relying on a spring mechanism for retraction, this model uses a hand-wound lever system to manually retract the leash.

Integrated into the housing is a hand-wound lever, ergonomically designed for easy and comfortable use. A key feature of this design is the inclusion of a divot in the housing, specifically designed to make space for the user to rotate the lever smoothly. This ensures that the retraction process is efficient and unimpeded by the housing itself. When the pet owner wants to retract the leash, they simply wind the lever, which spools the leash back into the housing. This manual retraction system allows the user to control the speed and tension of the leash retraction, making it particularly useful in situations where slow and steady retraction is necessary, such as when navigating through tight spaces or around obstacles. This added control can also be beneficial for training purposes, where precise leash management is required.

To enhance convenience and portability, the lever is designed to be foldable. When not in use, the lever can be folded flat against the housing, reducing the bulk and making the leash more compact and easier to carry. When needed, the lever can be easily folded out from the housing, ready for operation. This foldable design ensures that the leash remains sleek and unobtrusive when the manual retraction function is not in use.

The housing of the manual hand-powered version is constructed from lightweight, durable materials such as plastic or aluminum, ensuring it can withstand the rigors of regular use while remaining easy to handle. The housing also features an ergonomic handle portion designed for a comfortable grip during extended walks or activities.

In addition to the manual retraction system, the leash includes a quick leash release button mounted on the housing. This safety feature allows the leash to be rapidly disconnected from the housing in emergency situations. The mechanism involves a pull-pin connected to the quick leash release button via a cord, string, or cable. When the button is pressed, it moves the pull-pin, which can be magnetic, thereby disengaging the leash from the spool within the housing. This quick release function is crucial for preventing injuries or accidents when immediate disconnection of the leash is necessary.

The housing is designed to be easily opened and closed, allowing the pull-pin to be re-engaged with the leash after it has been released. This feature ensures that the leash can be quickly reset and made ready for use again without complicated procedures.

Overall, the manual hand-powered version of the extendable animal leash offers a reliable and user-friendly alternative to spring-based models. Its manual winding system, enhanced by a dedicated divot for smooth operation and a foldable lever for compactness, provides superior control over leash retraction. Meanwhile, the quick leash release button ensures safety in emergency situations. This version is ideal for pet owners who prefer a more hands-on approach to leash management, offering a balance of functionality, safety, and ease of use.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

1. An extendable animal leash comprising:
a housing;
a leash that extends out from the housing;
a spring recoil mechanism configured to retract the leash into the housing; and
a quick leash release button mounted on the housing, wherein the quick leash release button is configured to cause the leash to disconnect from the housing when engaged.

2. The extendable animal leash of claim 1, wherein the quick leash release button triggers a mechanism that releases the leash from a leash spool within the housing.

3. The extendable animal leash of claim 2, wherein the mechanism includes a pull-pin connected to a cord, a string, or a cable.

4. The extendable animal leash of claim 3, wherein the cord, string, or cable is also connected to the quick leash release button.

5. The extendable animal leash of claim 3, wherein moving movement of the quick leash release button causes the pull-pin to move.

6. The extendable animal leash of claim 2, wherein the mechanism includes a magnetic pull-pin that is configured to move when a magnetic force is applied to the magnetic pull-pin.

7. The extendable animal leash of claim 5, wherein the magnetic force is applied by moving a magnet that is coupled to the quick leash release button.

8. The extendable animal leash of claim 6, wherein the magnet is coupled to the quick leash release button via a cord, a string, or a cable.

9. The extendable animal leash of claim 6, wherein the magnet is coupled to the quick leash release button via an adhesive, a tie, a strap, a screw, a bolt, or a clip.

10. The extendable animal leash of claim 6, wherein the magnetic pull-pin is configured to move when the quick leash release button is moved.

11. The extendable animal leash of claim 1, further comprising a leash spool locking button mounted on the housing.

12. The extendable animal leash of claim 11, wherein the leash spool locking button is operable to fix the leash at a desired length by engaging with a leash spool brake within the housing.

13. The extendable animal leash of claim 1, wherein the housing includes a handle portion ergonomically designed for a comfortable grip.

14. The extendable animal leash of claim 11, wherein the spring recoil mechanism is tensioned to retract the leash automatically when the leash spool locking button is disengaged.

15. The extendable animal leash of claim 1, wherein the leash is made from a durable material such as a nylon material, a polyester material, or a leather material.

16. The extendable animal leash of claim 11, further comprising a leash spool brake mechanism operable by the leash spool lock button to provide gradual stopping of the leash extension.

17. The extendable animal leash of claim 1, wherein the housing is configured to be opened and closed so that the pull-pin can be reengaged with the leash.

18. The extendable animal leash of claim 2, wherein the mechanism includes a latch that is disengaged by the quick leash release button, allowing the leash to be detached from the leash spool.

19-20. (canceled)
